(19) United States
(12) Patent Application Publication
(10) Pub. No.: US 2026/0020113 A1
(43) Pub. Date: Jan. 15, 2026

(54) METAL CERAMICS HEATING DEVICE

(71) Applicant: Dongguan Lady merry Technology CO., LTD, Dongguan (CN)

(72) Inventors: Jinnong XU, Dongguan (CN); Zhen WANG, Fuyang (CN); Ye FENG, Pingxiang (CN); Jun Tang, Nanyang (CN)

(21) Appl. No.: 19/227,526

(22) Filed: Jun. 4, 2025

(30) Foreign Application Priority Data
Jul. 15, 2024 (CN) 202410942227.1

(51) Int. Cl. H05B 3/26; H05B 3/03

(52) U.S. Cl. CPC H05B 3/265; H05B 3/03; H05B 2203/003; H05B 2203/035

(57) ABSTRACT

A metal ceramics heating device, including a first ceramic body and a second ceramic body. An intermediate ceramic layer is provided between the first ceramic body and the second ceramic body. A first resistance wire is provided on a side of the first ceramic body close to the intermediate ceramic layer, the first resistance wire is formed by tungsten paste printing and sintering. A second resistance wire is provided on a side of the second ceramic body, the second resistance wire is formed by tungsten paste printing and sintering. The first resistance wire and second resistance wire both include a first heating circuit, a second heating circuit The metal ceramics heating device improves heat generation, achieves a wide voltage design for global voltages ranging from AC 100V to AC 240V, changes the traditional voltage control method for hair straightener, and realizes true dual voltage control.

### CROSS REFERENCE TO RELATED APPLICATIONS

This application claims foreign priority of Chinese Patent Applications No. 202410942227.1, filed on July 15, 2024 and 2024216636196 filed on July 15, 2024 in the China National Intellectual Property Administration, the disclosures of all of which are hereby incorporated by reference.

### TECHNICAL FIELD

The present disclosure relates to the technical field of ceramic heating, in particular to a metal ceramics heating device.

### BACKGROUND

A straightener is an electric device that straightens hair by utilizing the principle of protein denaturation when heated. Therefore, a good straightener requires a heating element with high-quality performance. Metal ceramic heater (MCH) is a type of ceramic heating element. Due to its rapid heating, lack of open flame, durability, and resistance to acids and alkalis, MCH is widely used in the straightener industry. MCH is made by printing resistive paste onto a ceramic substrate and then sintering it. Metal leads are drawn from both ends of the resistive paste, and when current passes through it, high temperatures are generated quickly, which then heats the straightener.

In practical use, the power of MCH changes with voltage variations, as different countries have different power grid voltages, such as AC100V or AC240V. When the resistance value is fixed, the power of the MCH changes with voltage fluctuations. Therefore, the MCH used in straighteners typically needs to be designed for specific voltages, and manufacturers must select MCH with different resistance values for different countries or regions. However, this lack of uniform specifications leads to difficulties in large-scale production, thus increasing production costs.

Although some straightener manufacturers have implemented so-called global voltage compatibility through circuit control, the rapid heating of MCH (which can reach over 700°C in 10 seconds) poses serious safety risks. Since the straightener directly affects the human hair, if the temperature becomes uncontrollable, excessively high temperatures can easily burn or even ignite the hair.

### SUMMARY

The present disclosure provides a metal ceramics heating device, to solve the technical problem that the temperature of straighteners is not easy to control.

To realize the above objective, the present disclosure provides a metal ceramics heating device, including a first ceramic body and a second ceramic body; an intermediate ceramic layer is provided between the first ceramic body and the second ceramic body; and a first resistance wire is provided on a side of the first ceramic body close to the intermediate ceramic layer, the first resistance wire is formed by tungsten paste printing and sintering; and a second resistance wire is provided on a side of the second ceramic body close to the intermediate ceramic layer, the second resistance wire is formed by tungsten paste printing and sintering; the first resistance wire and second resistance wire includes a first heating circuit, a second heating circuit; two ends of the first heating circuit are connected to a first electrode and a second electrode respectively; and two ends of the second heating circuit are connected to a first electrode and a third electrode respectively; and the first heating circuit and the second heating circuit are connected to an external control circuit through the first electrode to achieve common or separate control.

Furthermore, first electrode slots are defined on the first ceramic body, and the first electrode slots are configured for connecting external wires; second electrode slots are defined on a side of the intermediate ceramic body close to the first ceramic body, the second electrode slots are corresponded to the first electrode slots; the first electrode slots and the second electrode slots are aligned in a thickness direction of the metal ceramics heating device, to form through channels.

Furthermore, the number of the first electrode slots is 3, the number of the second electrode slots is 3; the first electrode, the second electrode and the third electrode are corresponded to the first electrode slots.

Furthermore, the first heating circuit and the second heating circuit are formed by printing and sintering tungsten paste, the first heating circuit and second heating circuits have different resistance values.

Furthermore, a side of the intermediate ceramic layer near the first resistance wire is screen printed with a first screen printing layer that matches the first ceramic body and the first resistance wire; and the first screen printing layer is configured to cover a non electrode area of the first resistance wire.

Furthermore, a side of the intermediate ceramic layer near the second resistance wire is screen printed with a second screen printing layer that matches the second resistance wire and the second ceramic body; and the second screen printing layer is configured to cover a non electrode area of the second resistance wire.

Furthermore, a total heating circuit is formed by the first heating circuit and the second heating circuit; a projection contour of the total heating circuit and the second resistance wire in the thickness direction of the metal ceramics heating device is overlapped.

Furthermore, a density and a length of the total heating circuit are not the same with that of the second resistance wire.

Furthermore, the first resistance wire and the second resistance wire are arranged in a serpentine winding pattern.

Furthermore, the first electrode is connected to an external wire A; and

the second electrode is connected to an external wire B; and the third electrode is connected to an external wire C.

The beneficial effects of the present disclosure compared to the prior art are as follows: (1) the disclosure achieves heating on both sides by printing heating circuits on both the first ceramic body and the second ceramic body, which increases the heating capacity; (2) the MCH in this disclosure adopts a "sandwich" new printing process and sintering, high-voltage circuits adopts the MCH with high resistance, while low-voltage regions adopts MCH with low resistance, the same MCH offers two resistance options, effectively ensuring the safety of users when using the hair straightener, at the same time, this allows MCH manufacturers to standardize production and improve productivity; (3) this disclosure changes the traditional voltage control method used in hair straightener, achieving true dual-voltage control; (4) in combination with the temperature control method of the hair straightener, easily achieves a wide voltage design that supports global voltages from AC 100V to AC 240V.

### BRIEF DESCRIPTION OF THE DRAWINGS

FIG. 1 is an exploded view of a metal ceramics heating device according to an embodiment of the present disclosure.

FIG. 2 is a schematic diagram of the metal ceramics heating device according to an embodiment of the present disclosure.

FIG. 3 is a block diagram of the metal ceramics heating device according to an embodiment of the present disclosure.

FIG. 4A is a first control circuit diagram of the metal ceramics heating device according to an embodiment of the present disclosure.

FIG. 4B is a second control circuit diagram of the metal ceramics heating device according to an embodiment of the present disclosure.

FIG. 4C is a third control circuit diagram of the metal ceramics heating device according to an embodiment of the present disclosure.

FIG. 4D is a fourth control circuit diagram of the metal ceramics heating device according to an embodiment of the present disclosure.

FIG. 4E is a fifth control circuit diagram of the metal ceramics heating device according to an embodiment of the present disclosure.

FIG. 4F is a sixth control circuit diagram of the metal ceramics heating device according to an embodiment of the present disclosure.

FIG. 4G is a seven control circuit diagram of the metal ceramics heating device according to an embodiment of the present disclosure.

Description of the reference numeral:

1 first ceramic body, 2 first resistance wire, 3 intermediate ceramic layer, 4 first resistance wire, 5 second ceramic body; 6 first screen printing layer, 7 second screen printing layer, 21 first heating circuit, 22 second heating circuit, 23 first electrode, 24 second electrode, 25 third electrode, 101 first electrode slot, 102 second electrode slot.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

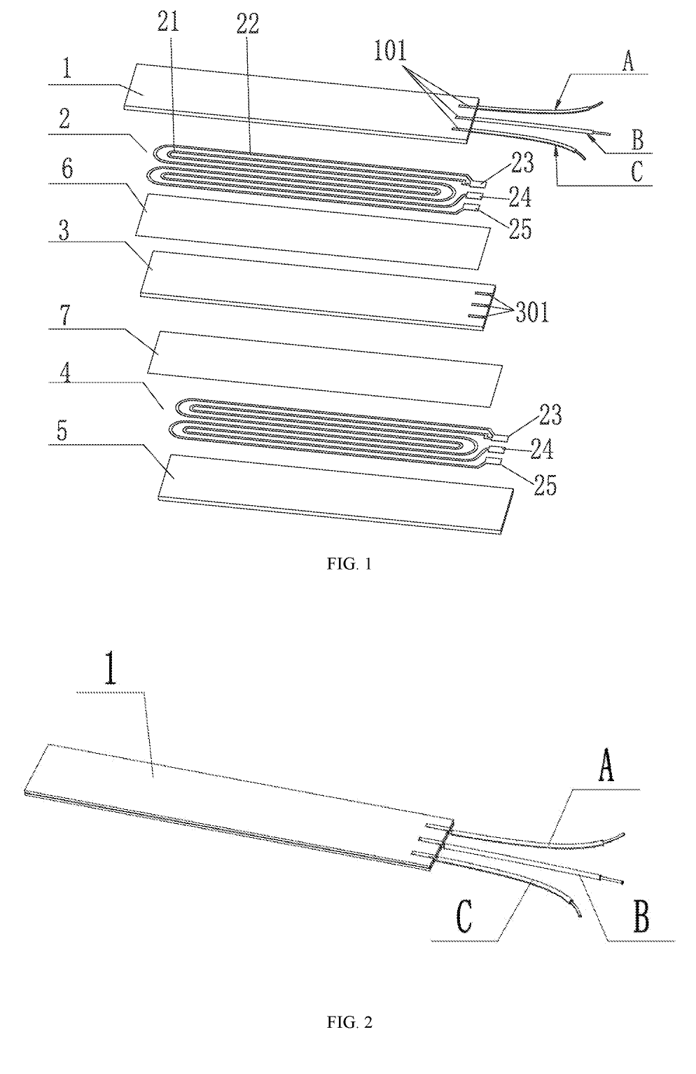

As shown in FIGS. 1 to 2, a metal ceramics heating device includes a first ceramic body 1 and a second ceramic body 5, with an intermediate ceramic layer 3 provided between the first ceramic body 1 and the second ceramic body 5. The first ceramic body 1 is provided with a first resistive wire 2 formed by tungsten paste printing and sintering on the side close to the intermediate ceramic layer 3. The second ceramic body 5 is provided with a second resistive wire 4 formed by tungsten paste printing and sintering on the side close to the intermediate ceramic layer 3. The first resistive wire 2 and the second resistive wire 4 each include independent first heating circuits 21 and second heating circuits 22. The two ends of the first heating circuit 21 are connected to the first electrode 23 and the second electrode 24 respectively, while the two ends of the second heating circuit 22 are connected to the first electrode 23 and the third electrode 25. The first heating circuits 21 and the second heating circuits and 22 are connected to an external control circuit through the first electrode 23, enabling either shared or separate control.

In some embodiments, the first ceramic body 1 is provided with first electrode slots 101 for connecting to an external control circuit. The intermediate ceramic layer 3, on the side near the first ceramic body 1, has second electrode slots 301 corresponding to the first electrode slots 101. The first electrode slots 101 and the second electrode slots 301 are aligned along a thickness direction of the metal ceramics heating device to form through channels.

In some embodiments, the number of the first electrode slots 101 and the second electrode slots 301 is three, with the first electrode 23, the second electrode 24, and the third electrode 25 each corresponding to one of the three first electrode slots 101.

In some embodiments, the first heating circuit 21 and the second heating circuit 22 are formed by sintering tungsten paste with different types or ratios, resulting in different resistance values for each circuit.

In some embodiments, the side of the intermediate ceramic layer 3, near the first resistive wire 2, is provided with a first screen printing layer 6 formed by screen printing, which matches the first ceramic body 1 and the first resistive wire 2. The first screen printing layer 6 corresponds to covering an non-electrode region of the first resistive wire 2. It is important to note that the non-electrode region refers to all areas of the first resistive wire 2 except those corresponding to the first electrode 23, the second electrode 24, and the third electrode 25.

In some embodiments, the side of the intermediate ceramic layer 3, near the second resistive wire 4, is provided with a second screen printing layer 7 formed by screen printing, which matches the second resistive wire 4 and the second ceramic body 5. The second screen printing layer 7 corresponds to covering the non-electrode region of the second resistive wire 4. Similarly, the non-electrode region here refers to all areas of the second resistive wire 4 except those corresponding to the first electrode 23, second electrode 24, and third electrode 25.

In some embodiments, the total heating circuit formed by the first heating circuit 21 and the second heating circuit 22 on the second ceramic body 5 overlaps with the projection profile of the second resistive wire 4 along the thickness direction of the metal ceramics heating device to enhance heat uniformity.

In some embodiments, the total heating circuit formed by the first heating circuit 21 and the second heating circuit 22 on the second ceramic body 5 has different densities and lengths compared to the second resistive wire 4, in order to achieve different heating effects.

In some embodiments, the first electrodes 23 on the first resistive wire 2 and the second resistive wire 4 are connected to an external wire A, the second electrodes on the first and second resistive wires 2 and 4 are connected to an external wire B, and the third electrodes on the first and second resistive wires 2 and 4 are connected to an external wire C. This allows both layers to heat up, improving the total heat output. The first heating circuit 21 and the second heating circuit 22 are formed by sintering tungsten paste with different types or ratios, resulting in different resistance values, such as 25 ohms for the external wire A and the external wire A, and 50 ohms for the external wire A and the external wire A.

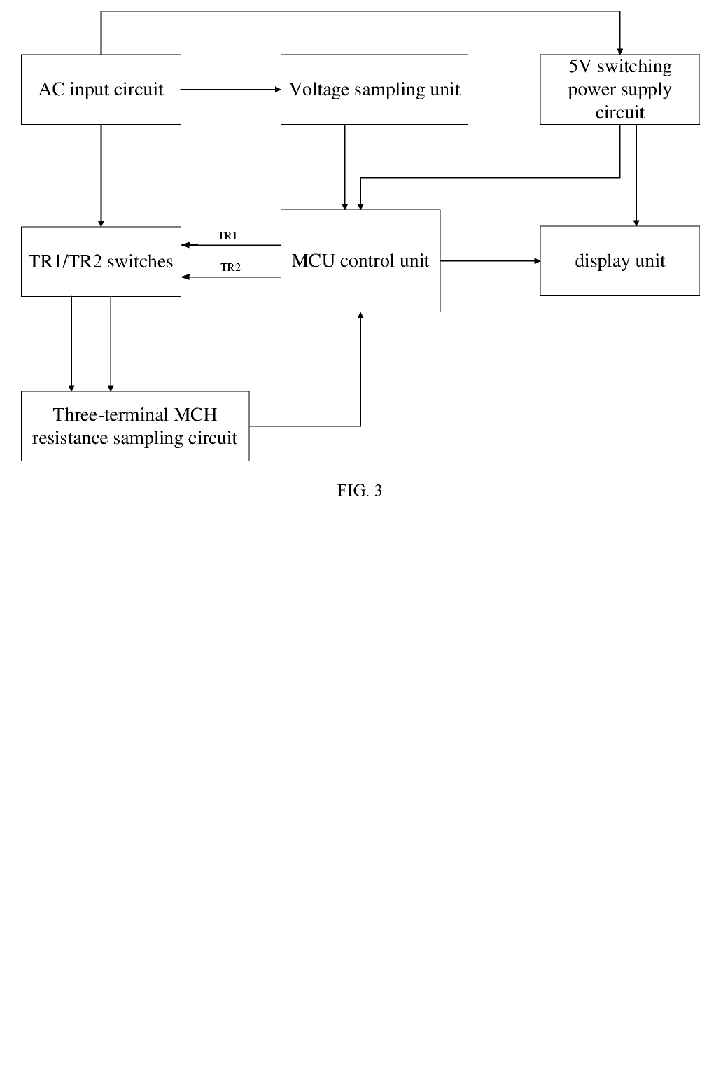

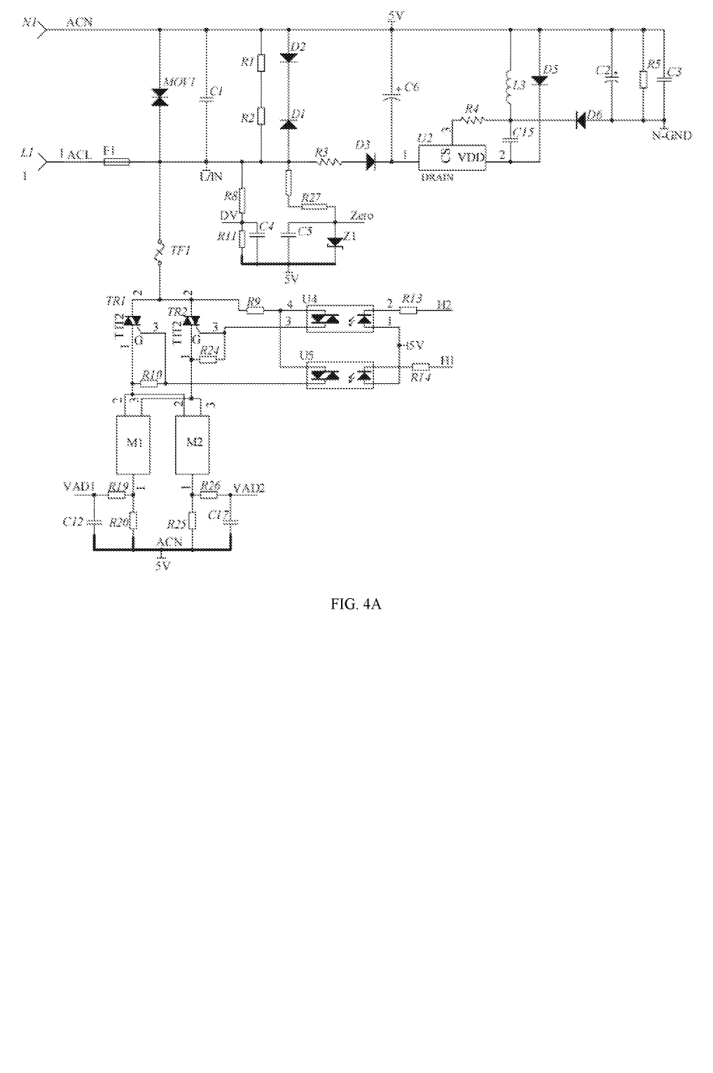

This embodiment provides a control circuit for the metal ceramics heating device mentioned above, as shown in FIG. 3, the control circuit including:

an alternating current (AC) input circuit configured for receiving alternating current from a power grid or an external power source;

a voltage sampling unit configured for monitoring input voltage of the AC input circuit and feeding information back to a microcontroller unit (MCU) to ensure stable power supply;

a five voltage switching power supply circuit configured for converting alternating current to direct current and providing a stable 5V output voltage;

a first thermal relay (TR1) switch and a second thermal relay (TR2) switch configured for controlling a direction or magnitude of the current flow;

a MCU control unit configured for receiving information from the voltage sampling unit and controls the TR1 switch and the TR2 switch, to adjust the power supply; when the voltage sampling unit detects that the voltage from the power grid or the external power source is 100V AC, the MCU is configured to turn on the TR1 switch and turn off the TR2 switch; and when the voltage sampling unit detects that the voltage from the power grid or the external power source is 240V AC, the MCU is configured to turn on the TR2 switch and turn off the TR1 switch.

A display unit, configured for displaying the current status information to the user.

A three-terminal metal ceramics heater (MCH) resistance sampling circuit, configured for measuring the current intensity and monitoring it through the MCU.

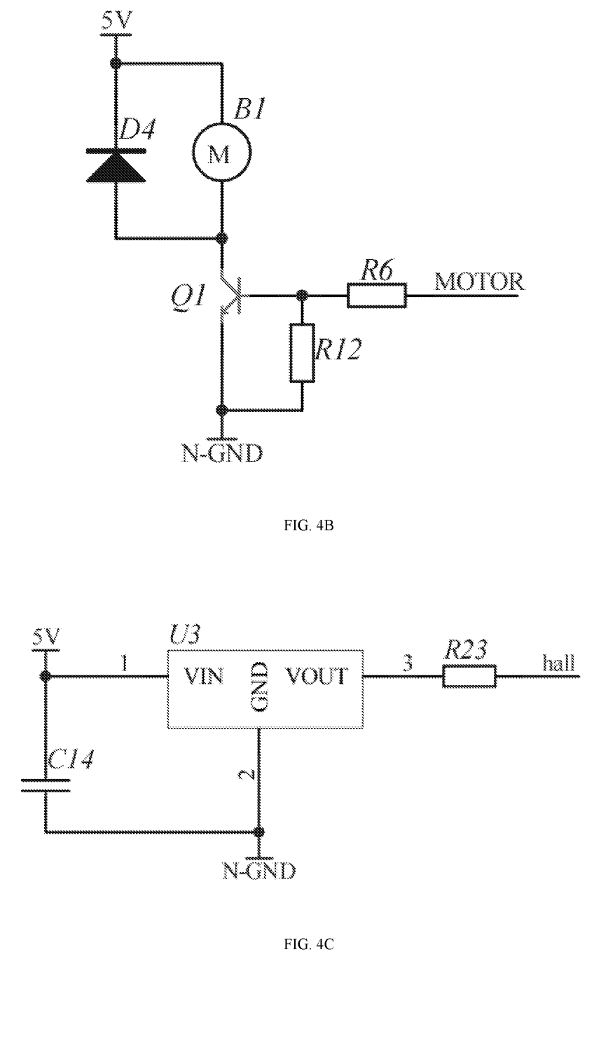

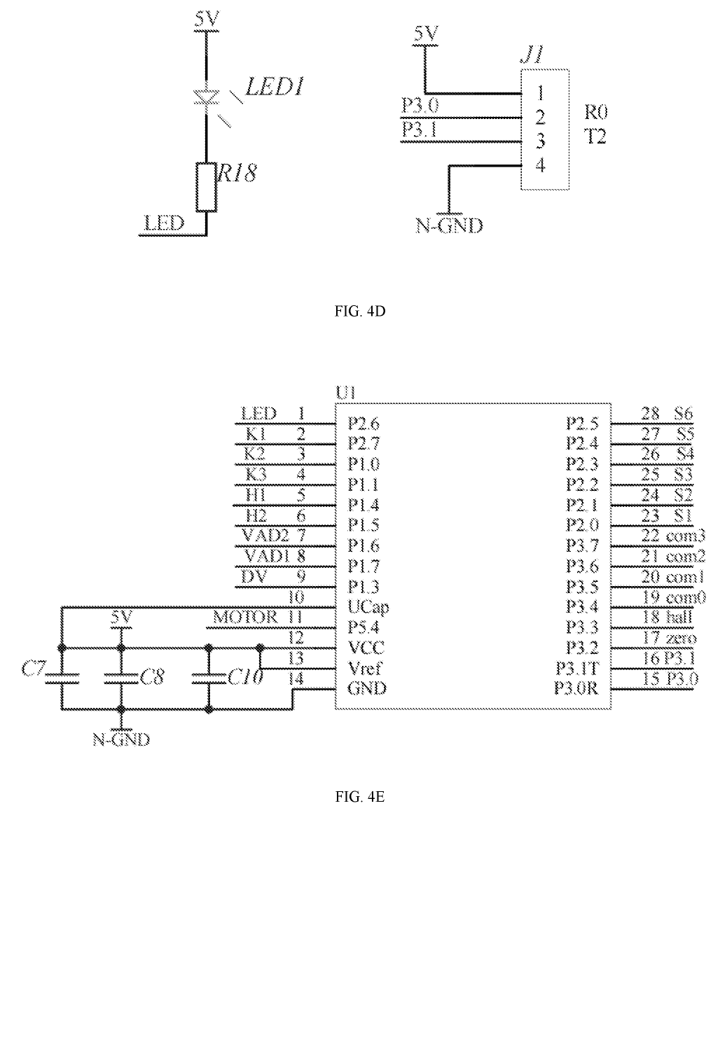

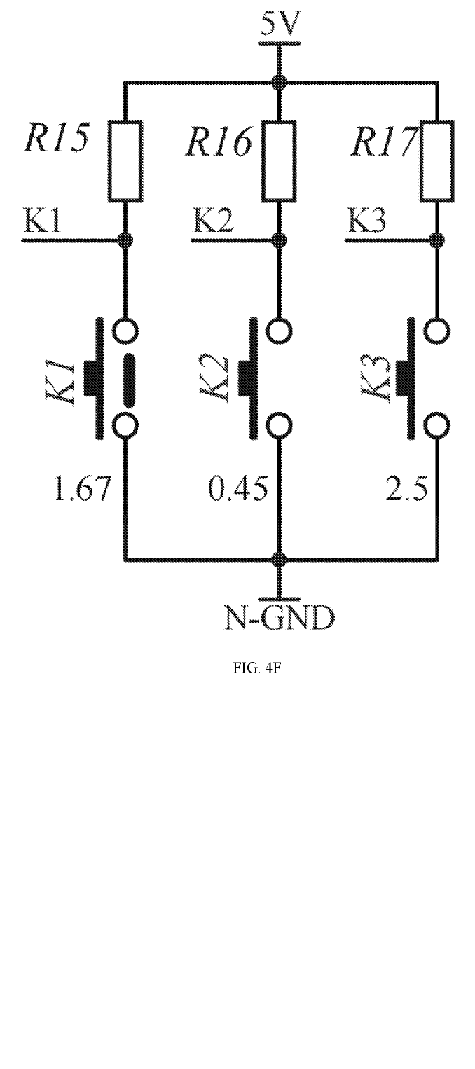

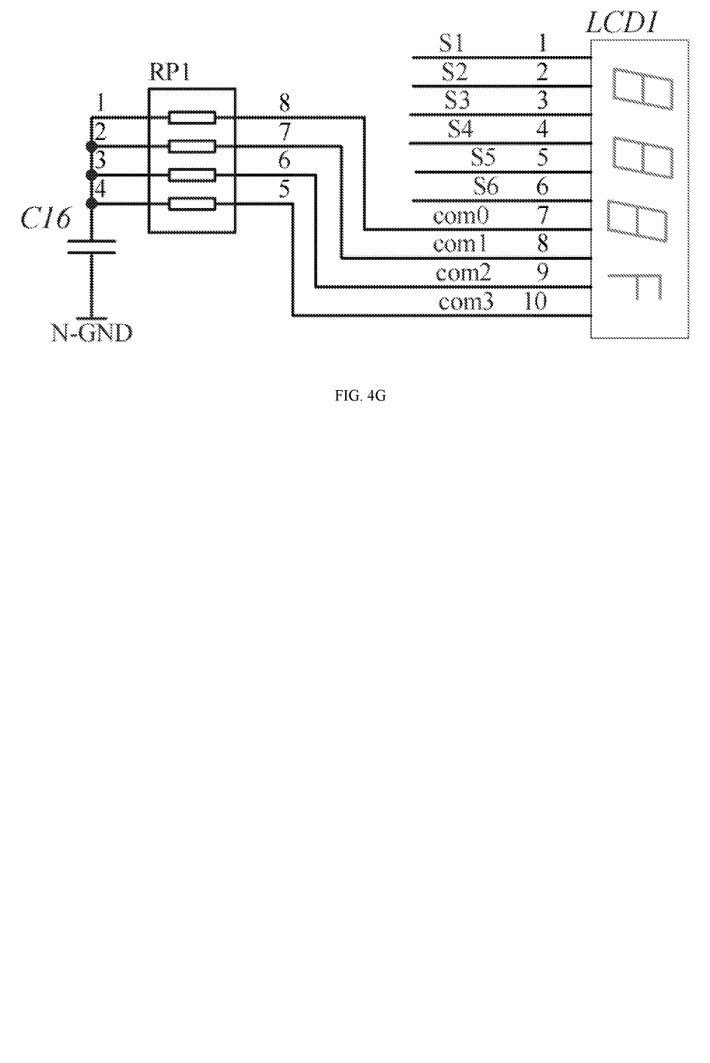

As shown in FIGS. 4A-4G, the working principle of the disclosure is as follows. The traditional MCH manufacturing process only prints a heating wire and two electrodes placed at the connections. The present disclosure, based on the traditional MCH manufacturing process, adds an extra heating wire and introduces an additional external wire in the middle. When developing a hair straightener, users can choose as needed. When AC 110V is required, external wire A and external wire B are used (low resistance value) to connect to external control circuit; when AC 240V is required, external wire A and external wire C are used (high resistance value) to connect to external control circuit.

The specific control method of the control circuit is as follows: when the voltage sampling unit detects that the voltage of the currently used grid or external power supply is 100V AC, the MCU control unit controls the I/O to output a high-level H3 signal to turn on TR1, turn off TR2, and work on the 2-1 configuration of M1/M2. When the voltage sampling unit detects that the voltage of the currently used grid or external power supply is 240VAC, the MCU control unit controls the I/O to output a high-level H2 signal to turn on TR2, turn off TR1, and work on the 2-1 configuration of M1/M2. M1/M2 refers to the metal ceramics heating device in this disclosure.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A metal ceramics heating device, comprising a first ceramic body and a second ceramic body;
wherein an intermediate ceramic layer is provided between the first ceramic body and the second ceramic body; and
a first resistance wire is provided on a side of the first ceramic body close to the intermediate ceramic layer, the first resistance wire is formed by tungsten paste printing and sintering; and
a second resistance wire is provided on a side of the second ceramic body close to the intermediate ceramic layer, the second resistance wire is formed by tungsten paste printing and sintering;
wherein the first resistance wire and second resistance wire comprise a first heating circuit, a second heating circuit; two ends of the first heating circuit are connected to a first electrode and a second electrode respectively; and two ends of the second heating circuit are connected to a first electrode and a third electrode respectively; and
the first heating circuit and the second heating circuit are connected to an external control circuit through the first electrode to achieve commonor separate control.

2. The metal ceramics heating device according to claim 1, wherein first electrode slots are defined on the first ceramic body, and the first electrode slots are configured for connecting external wires;
second electrode slots are defined on a side of the intermediate ceramic body close to the first ceramic body, the second electrode slots are corresponded to the first electrode slots;
the first electrode slots and the second electrode slots are aligned in a thickness direction of the metal ceramics heating device, to form through channels.

3. The metal ceramics heating device according to claim 1, wherein the number of the first electrode slots is 3, the number of the second electrode slots is 3; the first electrode, the second electrode and the third electrode are corresponded to the first electrode slots.

4. The metal ceramics heating device according to claim 1, wherein the first heating circuit and the second heating circuit are formed by printing and sintering tungsten paste, the first heating circuit and second heating circuits have different resistance values.

5. The metal ceramics heating device according to claim 1, wherein a side of the intermediate ceramic layer near the first resistance wire is screen printed with a first screen printing layer that matches the first ceramic body and the first resistance wire; and the first screen printing layer is configured to cover a non electrode area of the first resistance wire.

6. The metal ceramics heating device according to claim 1, wherein a side of the intermediate ceramic layer near the second resistance wire is screen printed with a second screen printing layer that matches the second resistance wire and the second ceramic body; and the second screen printing layer is configured to cover a non electrode area of the second resistance wire.

7. The metal ceramics heating device according to claim 1, wherein a total heating circuit is formed by the first heating circuit and the second heating circuit;
a projection contour of the total heating circuit and the second resistance wire in the thickness direction of the metal ceramics heating device is overlapped.

8. The metal ceramics heating device according to claim 7, wherein a density and a length of the total heating circuit are not the same with that of the second resistance wire.

9. The metal ceramics heating device according to claim 1, wherein the first resistance wire and the second resistance wire are both arranged in a serpentine winding pattern.

10. The metal ceramics heating device according to claim 1, wherein the first electrode is both connected to an external wire A; and
the second electrode is connected to an external wire B; and
the third electrode is both connected to an external wire C.
